(19) United States
(12) Patent Application Publication
(10) Pub. No.: US 2004/0118949 A1
(43) Pub. Date: Jun. 24, 2004

(54) Shower Nozzle

(76) Inventor: Kipley Roydon Marks, Auckland (NZ)

Correspondence Address: YOUNG & THOMPSON, 745 SOUTH 23RD STREET 2ND FLOOR, ARLINGTON, VA, 22202

(21) Appl. No.: 10/325,820

(22) Filed: Dec. 23, 2002

(51) Int. Cl. B05B 1/14

(52) U.S. Cl. 239/550

(57) ABSTRACT

A shower nozzle assembly is provided having a nozzle member that slides on an elongate slide bar mounted generally vertically on a wall of a shower installation. The position of the nozzle member can be adjusted on the slide bar to suit the height of a user, and has a U-bend adjacent to an upper end to provide a water inlet to the nozzle member. A flexible water conduit is provided between a water supply connection point of the shower installation and the water inlet. The water conduit is sufficiently long for at least a portion of the water conduit to extend past the water inlet irrespective of the position of the nozzle member relative to the slide bar.

### FIELD OF THE INVENTION

This invention relates to a shower nozzle assembly, and is directed particularly, but not solely, toward slidable shower nozzle assemblies.

### BACKGROUND

A. Prior Art

A variety of different shower nozzle arrangements are known. Some such arrangements, including one particular slidable shower nozzle assembly, are described in my earlier patent application published under the Publication No. WO 99/59456 (hereinafter referred to as “my earlier application”), the content of which is incorporated herein by reference in its entirety.

The preferred embodiment of the slidable shower nozzle assembly disclosed in my earlier application suffers a number of disadvantages. These include the slidable hydraulic supply mechanism being susceptible to water pressure from a mains supply, resulting in the slidable nozzle being forced downwardly toward the lowest position of travel on the slide bar. Consequently, this arrangement makes adjustment of the nozzle member difficult for users. In particular, trying to adjust the nozzle member in an upward direction while the nozzle is in use is extremely difficult for many users. Also, attempting to maintain the nozzle in a stationary position while the unit is in use is also quite difficult for users.

Another disadvantage with the preferred embodiment described in my earlier application is that the shower nozzle had to be located carefully with respect to the water supply (i.e. bathroom plumbing) connection point, so there was little latitude for errors in placement of the shower nozzle. Also, the installer had very little flexibility in deciding where the shower nozzle was to be placed in the shower installation.

It is an object of the present invention to provide an improved shower nozzle assembly or method of assembling a shower nozzle which will at least go some way toward overcoming disadvantages suffered by the prior art, or which will alternatively at least provide the public with a useful choice.

B. General Discussion of the Invention

In one aspect the invention provides a shower nozzle assembly including:

an elongate slide bar for mounting substantially vertically on a wall of a shower installation;

a nozzle member having a first end and a second end and being capable of sliding engagement with the slide bar to allow the position of the nozzle member relative to the slide bar to be adjusted, and having a U-bend adjacent to the first end providing a water inlet to the nozzle member;

a shower spray nozzle provided on the nozzle member for emission of water;

a water supply connection point; and

a flexible water conduit for communicable connection between the water supply connection point and the water inlet, the water conduit being of a length sufficient for at least a portion of the water conduit to extend past the water inlet irrespective of the position of the nozzle member relative to the slide bar.

In another aspect the invention provides a shower nozzle including:

a plurality of outlet shower spray nozzles provided in a substantially side by side relationship, each nozzle having an inlet for water supply thereto;

an elongate water distribution conduit having a water inlet for connection to a water supply, and a plurality of water outlet apertures, each outlet aperture being provided immediately adjacent to, and communicably connected to, a corresponding inlet to each shower spray nozzle; and

a part of each nozzle adjacent to the inlet having a substantially concave surface profile adapted to be contiguous with a convex surface profile of the distribution conduit adjacent to the corresponding outlet aperture.

In yet another aspect the invention provides a method of assembling a shower nozzle, the method including the stops of:

providing a plurality of shower spray outlet nozzles, each nozzle having an inlet for water supply thereto and a spray outlet for emission of water;

providing an elongate water distribution conduit with a plurality of outlet apertures therein;

providing a part of each nozzle adjacent to the inlet with a substantially concave surface profile adapted to be contiguous with a convex surface profile adjacent to a corresponding outlet aperture of the distribution conduit;

sealably affixing the substantially concave surface of each shower spray outlet nozzle to a portion of the distribution conduit.

In a further aspect the invention provides a method of assembling a shower nozzle, the method including the steps of;

providing a plurality of shower spray outlet nozzles, each nozzle having an inlet for water supply thereto and a spray outlet for emission of water;

providing an elongate water distribution conduit;

sealably affixing a part of each nozzle adjacent to the inlet with part of an outer surface of the distribution conduit; and

creating a plurality of outlet apertures in the distribution conduit to allow water to enter the inlet apertures by forming apertures in a wall of the distribution conduit so that each outlet aperture is substantially coincident with each of the inlets

To those skilled in the art which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists of the foregoing and also envisages constructions of which the following gives examples.

### DRAWING DESCRIPTION

One preferred form of the present invention will now be described with reference to the accompanying drawings in which;

FIG. 1 is a front elevation of a shower nozzle assembly according to the present invention.

FIG. 2 is a side elevation in partial cross section of the apparatus of FIG. 1.

FIG. 3 is a more detailed view of a part of FIG. 2.

FIG. 4 is a partial plan view in cross section showing the interconnection between a water supply conduit and a shower spray outlet nozzle as indicated in line AA of FIG. 3.

### DETAILED DESCRIPTION

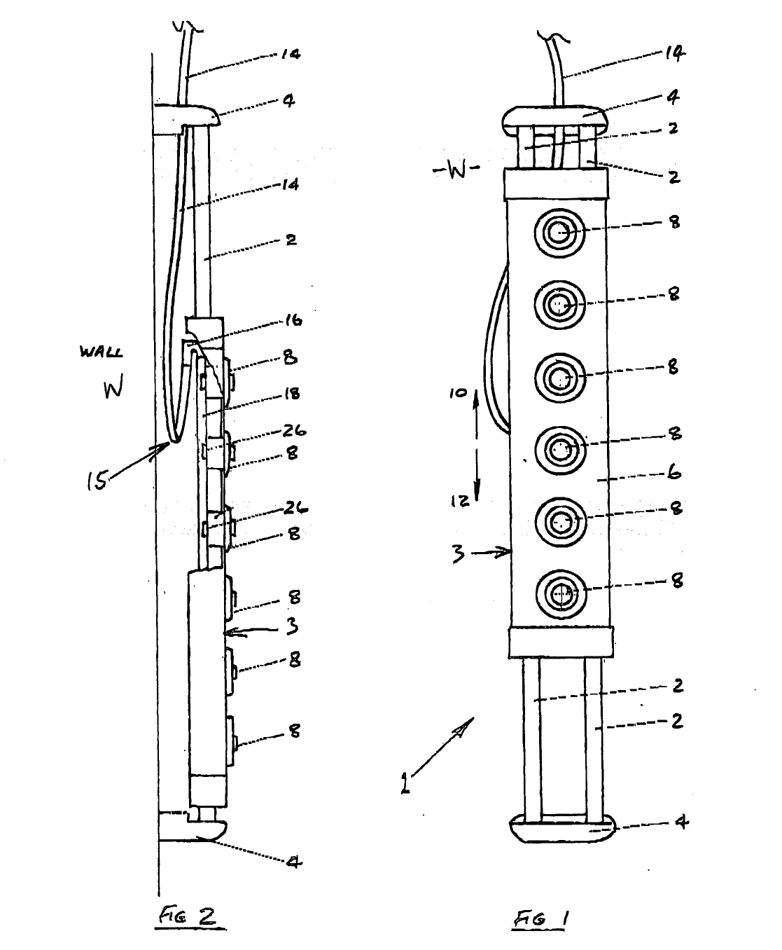

Referring to FIG. 1, a preferred embodiment of a shower nozzle assembly in accordance with the invention is shown generally referenced 1. The apparatus has two slide bars 2 which have mounting members 4 at either end. The mounting members 4 are in use bolted, screwed, glued or otherwise fixed to a wall W of a shower or shower bath installation. For the purposes of illustrating the present invention, and in the preferred embodiment, two slide bars 2 are shown. However, if desired, a single slide bar may be used. Also, more than two slide bars may be used. As can be seen from the drawings, slide bars 2 are arranged substantially vertically in the shower installation and provide a support for a nozzle member generally referenced 3. Also, the unit may be mounted in the inverted position from that shown in the drawings.

The nozzle member 3 is slidably mounted on slide bars 2. The nozzle member 3 has a number of outlet shower spray nozzles 8. The nozzles 8 are supported in a housing 6 and each of the nozzles 8 has one or more nozzle outlet spray apertures which are not referenced in the drawings for purposes of clarity. These have the effect of providing a spray or shower of water to a user in the known way. In the preferred embodiment, each of the nozzles 8 is directionally adjustable to a limited extent, but each is mounted to that, at least when the nozzle is in its central position, the spray of water which is emitted from each nozzle is in a direction which is substantially perpendicular to the wall on which the apparatus is mounted. Therefore the intention is that the array of nozzles B provides a shower of water over the torso of a user. Thus, when a user is standing in front of the apparatus, the user's torso will be exposed in a vertical direction to the vertical array of nozzles. The general columnar arrangement of nozzles shown in the drawings is most preferred but those skilled in the art will see that other arrangements are possible, for example two or three vertical rows of nozzles that extend vertically, but are not necessarily vertically aligned.

As indicated by arrows 10 and 12 in FIG. 1, the nozzle member 3 may be moved up, as shown by arrow 10, or down, as shown by arrow 12, along the slide bars 2 so that a user can adjust the nozzle member 3 vertically relative to the bars 2. Therefore, the apparatus can be adjusted depending upon the height of the user. Frictional engagement between the housing 6 and the bars 2 is sufficient in the preferred form of the invention to maintain the nozzle member 3 in a desired position, while also not being sufficiently great so as to impede adjustment by a user.

As described above, water exits the nozzle member 3 through the spray apertures of spray nozzles 8. The water enters the nozzle member 3 through a flexible inlet conduit 14. The upper end of conduit 14 is connected to a water supply connection of the bathroom plumbing for the shower installation, such as the diverter valve disclosed in my earlier application. However, the water supply connection to which conduit 14 is connected may comprise other water supply connections such as the outlet from a mixer for example.

The other end of conduit 14 is connected to an inlet to the nozzle member 3.

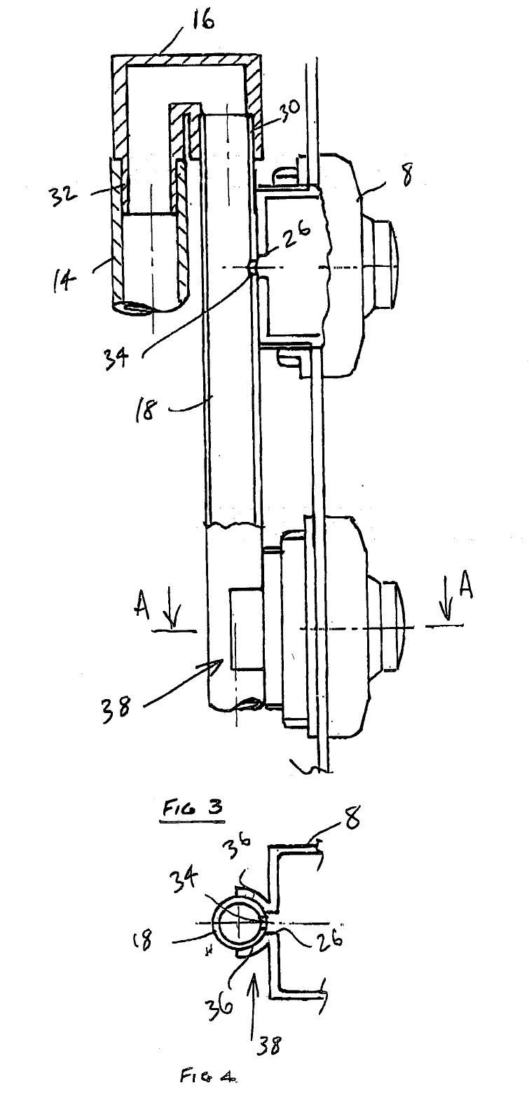

Turning to FIG. 2, the connection between the conduit 14 and nozzle member 3 is shown in greater detail. In particular, FIG. 2 shows a U-bend 16. One end of the U-bend 16 is connected to the conduit 14 and this provides an inlet for liquid to enter the nozzle member 3. The other end of the U-bend 16 is affixed to a distribution conduit 18 of the nozzle member 3. Although the U-bend is illustrated as a separate component, it may be provided as a part of the nozzle member 3, for example it may be formed as an integral part of conduit 18. The U-bend provides an inlet to the nozzle member 3 which is essentially parallel to the wall W. In the preferred embodiment, the inlet provided by the U-bend faces downwardly, as shown in the drawings. The U-bend 16 is connected to an upper end of the conduit 18. The lower end of conduit 18 (not shown in the drawings) is sealed. However, the distribution conduit 18 has a plurality of apertures (not shown in FIG. 2) which are adjacent to inlets 26 of each of the outlet nozzles B. The interconnection is described in more detail with reference to FIGS. 3 and 4 below.

The water supply connection is preferably but not necessarily provided near or above the upper limit of travel of the nozzle member 3. The conduit 14 is sufficiently long so that at the lower limit of travel of the nozzle member 3, as shown in FIG. 2, there is still a portion (in the form of a loop or bend) of the conduit 14 (shown generally by arrow 15) which lies beneath the inlet to U-bend 16. This arrangement has a number of advantages. Firstly, it allows complete freedom of movement of the nozzle member 3.

Secondly, there is no hydraulic pressure on the apparatus which will result in unintentional movement of the nozzle member 3 relative to the slide bars. Thirdly, the arrangement of the conduit 14 is such that it substantially lies behind the nozzle member 3, so that it is substantially concealed in use. The provision of the U-bend 16 means that another bend in the flexible conduit 14 is not required. Also, the U-bend can be provided in the position shown in FIG. 2, or can be rotated to one side (i.e. so that the inlet is in substantially the same plane as the slide bars 2) in case the distance between the slide bars 2 and the wall W needs to be reduced in any particular installation. The provision of liquid to the upper part of the distribution conduit 18 has the advantage that the conduit 18 fills up in use. Therefore, supply pressure problems affecting the upper outlet nozzles 8 are less likely if the supply pressure is undesirable low. Finally, flexible conduit 14 allows the assembly 1 to be located in a position in which it is not necessarily immediately below the water supply connection. As mentioned above, the installation may be completely inverted, with the water supply connection point provided near or below the lower end of travel of the nozzle member.

Turning now to FIG. 3, the arrangement and interconnection of the distribution conduit 18, U-bend 16 and supply conduit 14 is shown in more detail in partial cross-section. The conduit 18 is provided in the form of a tube and the U-bend or elbow 16 is connected about the upper end 30 of conduit 18. The U-bend 16 is preferably constructed from a substantially rigid plastics material and sealing between the U-bend and conduits 18 and conduit 14 can be affected by gluing for example. The relevant end of the flexible conduit 14 is located about an outer surface 32 of U-bend 16. Therefore, the apparatus is easily assembled in use.

FIG. 3 also shows the inter-connection between the inlet 26 to each of the nozzle outlets 8, and the distribution conduit 18. Each inlet 26 substantially coincides with an outlet aperture 34 in conduit 18. Therefore, water in the conduit 18 will exit that conduit through each of the outlets 34 whereupon it will enter the nozzle outlets 8 through corresponding inlets 28 and from there be expelled from the relevant nozzle member.

In the portion of FIG. 3 that is not shown in cross-section, an exterior surface (generally referenced 38) of the region near inlet 26 is shown. From this view, and with reference to FIG. 4 (which is a partial plan view), it will be seen that the rear of each of the nozzle outlets 8 has a surface portion 36 which is profiled or contoured to match (i.e. to be contiguous with) the outer profile or contour of the distribution conduit 18.

Profiled surfaces 36 allow a sealing connection to be made between the inlet 26 and outlet 34. In this way a simple glued connection between the mating surfaces allows the sealed connection to be made.

The preferred method of sealed inter-connection between each of the nozzle members 8 and the distribution conduit 18 is as follows. The conduit 18 is provided in the form of a tube of plastic material and is cut to the required length. In use, each nozzle member 8 is formed from a plastic material and is provided in at least two parts, a rear part or body that defines inlet 25 and a removable facia part which will typically contain the outlet aperture or apertures. The body portions of each of the nozzle members 8 are placed with surfaces 36 in contact with the outer surface of distribution conduit 18 at desired spaced locations along the length of the conduit. The body portions of the nozzle members 8 are then seal welded to the conduit 18. The welds form a continuous seal between each body and the conduit. The seal is formed around the inlet 26 to each body. With the facia portion of each nozzle 8 removed, a user can then drill apertures 34 into the distribution conduit 18, using inlet aperture 28 as a guide reference. The outlets 34 are now formed and are communicably coupled to the inlets 26. Then, the facia portions of the outlets 8 can be attached to complete the process.

The arrangement described above has the advantages that it allows a very quick and simple method of connecting all the nozzle outlets 8 together using a single full length rigid pipe which straddles the entry points of all the outlet bodies. Rather than use a seal welding process as mentioned above, the sealed connection between the nozzle bodies and the distribution pipe or conduit 18 can be made by gluing each body to the conduit 18. In particular, the advantage provided is that water can go from one outlet nozzle to another without any complex cutting or gluing being required between the pipe and the various nozzles. This eliminates significant labour cost.

1. A shower nozzle assembly including:
an elongate slide bar for mounting substantially vertically on a wall of a shower installation;
a nozzle member having a first end and a second end and being capable of sliding engagement with the slide bar to allow the position of the nozzle member relative to the slide bar to be adjusted, and having a U-bend adjacent to the first end providing a water inlet to the nozzle member;
a shower spray nozzle provided on the nozzle member for emission of water;
a water supply connection point; and
a flexible water conduit for communicable connection between the water supply connection point and the water inlet, the water conduit being of a length sufficient for at least a portion of the water conduit to extend past the water inlet irrespective of the position of the nozzle member relative to the slide bar.

2. A shower nozzle assembly as claimed in claim 1 wherein the U-bend provides a water inlet to the nozzle member that faces toward the opposite end of the nozzle member.

3. A shower nozzle assembly as claimed in claim 1 wherein the nozzle member includes a plurality of shower spray nozzles that are longitudinally spaced.

4. A shower nozzle assembly as claimed in claim 1 wherein the nozzle member includes a plurality of shower spray nozzles and the nozzle member includes an elongate water distribution conduit having a plurality of outlet apertures, each outlet aperture providing water to a shower spray nozzle.

5. A shower nozzle assembly as claimed in claim 4 wherein the U-bend is provided at an end of the water distribution conduit.

6. A shower nozzle assembly as claimed in claim 4 wherein each shower spray nozzle has a water inlet which is communicably connected to a corresponding outlet of the water distribution conduit, and a part of each nozzle adjacent to the inlet has a substantially concave surface profile adapted to be contiguous with a convex surface profile of the distribution conduit adjacent to the corresponding outlet aperture.

7. A shower nozzle assembly as claimed in claim 1 wherein the shower spray nozzle has a base member and a separable cover member, the base member has a water inlet, and a cover member has at least one outlet spray aperture.

8. A shower nozzle assembly as claimed in claim 7 wherein a plurality of shower spray nozzles are provided and the nozzle member has a water distribution conduit with a plurality of outlet apertures, the base members attached to the distribution conduit such that the outlet apertures are communicably connected to the inlets of the base members.

9. A shower nozzle including:
a plurality of outlet shower spray nozzles provided in a substantially side by side relationship, each shower spray nozzle having an inlet for water supply thereto;
an elongate water distribution conduit having a water inlet for connection to a water supply, and a plurality of water outlet apertures, each outlet aperture being provided immediately adjacent to, and communicably connected to, a corresponding inlet to each shower spray nozzle; and
a part of each nozzle adjacent to the inlet having a substantially concave surface profile adapted to be contiguous with a convex surface profile of the distribution conduit adjacent to the corresponding outlet aperture.

10. A shower nozzle as claimed in claim 9 wherein each outlet shower spray nozzle includes a base member and a separable cover member, the base member including a water inlet to the shower spray nozzle and the cover member having at least one outlet spray aperture.

11. A shower nozzle as claimed in claim 9 wherein the water inlet of the elongate water distribution conduit is connected to a U-bend.

12. A shower nozzle as claimed in claim 9 including a flexible water supply conduit having two ends, one end connected to the water inlet, and the other end adapted to be connected to a bathroom water supply plumbing.

13. A shower nozzle as claimed in claim 11 including a flexible water supply conduit having two ends, one end connected to an inlet to the U-bend, and the other and adapted to be connected to a bathroom water supply plumbing.

14. A shower nozzle as claimed in claim 9 including mounting means for slidably mounting the nozzle on an elongate slide bar.

15. A shower nozzle as claimed in claim 14 wherein the mounting means allow the position of the nozzle relative to the slide bar to be adjusted between an upper position and a lower position.

16. A method of assembling a shower nozzle, the method including the steps of:
providing a plurality of shower spray outlet nozzles, each nozzle having an inlet for water supply thereto and a spray outlet for emission of water;
providing an elongate water distribution conduit with a plurality of outlet apertures therein;
providing a part of each nozzle adjacent to the inlet with a substantially concave surface profile adapted to be contiguous with a convex surface profile of the distribution conduit adjacent to a corresponding outlet aperture conduit; and
sealably affixing the substantially concave surface of each shower spray outlet nozzle to a portion of the distribution conduit.

17. A method as claimed in claim 16 wherein the step of providing the distribution conduit with a plurality of outlet apertures comprises a step of creating apertures in a wall of the distribution conduit after the step of affixing the substantially concave surface of each shower spray outlet nozzle to a portion of the distribution conduit.

18. A method as claimed in claim 16 wherein each shower spray outlet nozzle comprises a base member and a separable cover member, the inlet being provided in a base member and the spray outlet being provided in the cover member, end the step of providing a part of each nozzle with a substantially concave surface profile comprises a step of providing a part of the base member adjacent to the inlet with a substantially concave surface profile.

19. A method as claimed in claim 18 including the step of suitably affixing the substantially concave surface of each shower spray outlet nozzle to a surface of the distribution conduit with the cover portion removed, and creating each outlet aperture by forming apertures in a wall of the distribution conduit each aperture being substantially co-incident with each inlet, and affixing the cover members.

20. A method of assembling a shower nozzle, the method including the steps of;
providing a plurality of shower spray outlet nozzles, each nozzle having an inlet for water supply thereto and a spray outlet for emission of water;
providing an elongate water distribution conduit;
sealably affixing a part of each nozzle adjacent to the inlet with part of an outer surface of the distribution conduit; and
creating a plurality of outlet apertures in the distribution conduit to allow water to enter the inlet apertures by forming apertures in a wall of the distribution conduit so that each outlet aperture is substantially co-incident with each of the inlets.

21. A method as claimed in claim 20 wherein each of the shower spray outlet nozzles includes a base member and a separable cover member, the inlet being provided in the bass member and at least one shower spray aperture being provided in the cover member, and the method includes the step of creating the outlet apertures in the water distribution conduit when the cover members are removed, then affixing the cover members to the base members.
